(19) United States
(12) Patent Application Publication
(10) Pub. No.: US 2013/0128979 A1
(43) Pub. Date: May 23, 2013

(54) VIDEO SIGNAL COMPRESSION CODING

(71) Applicants: Anthony Richard Jones, Hampshire (GB); Alois Martin Bock, Hampshire (GB); Kuan Lee, Hampshire (GB)

(72) Inventors: Anthony Richard Jones, Hampshire (GB); Alois Martin Bock, Hampshire (GB); Kuan Lee, Hampshire (GB)

(73) Assignee: TELEFONAKTIEBOLAGET LM ERICSSON (publ), Stockholm (SE)

(21) Appl. No.: 13/697,026

(22) PCT Filed: May 11, 2010
(86) PCT No.: PCT/EP10/56502

§ 371 Date: Jan. 4, 2013

(51) Int. Cl. H04N 7/26

(52) U.S. Cl. CPC H04N 19/00733
USPC 375/240.16; 375/240.01; 375/240.24

(57) ABSTRACT

The invention relates to the compression coding of video signals. The invention may be applied in some embodiments to the compression coding of three dimensional television (3DTV) signals. The invention provides a method of coding of a video signal, in which the presence of at least a first image area and a second image area in a picture, in which the images in the first image area and in the second image area are substantially identical is determined. In response to a positive determination, picture information in one image area is compression coded without reference to picture information in another image area. The invention also provides a video coder for coding a video signal.

### TECHNICAL FIELD

The invention relates to the compression coding of video signals. The invention may be applied in some embodiments to the compression coding of three dimensional television (3DTV) signals.

### BACKGROUND

Whilst viewing conventional electronic television images on a 2 dimensional (2D) display screen has been the norm for many years, there has also been strong interest in extending the experience to stereoscopic or three dimensional television (3DTV). Such schemes aspire to offer individual signals to each eye such that the brain constructs the illusion of 3 dimensional space, thus providing much more realism. The use of two separate but closely related images of the same scene delivered independently to each eye provides the basis of so called stereoscopic TV.

Systems in which 3DTV may be supported using simple adaptation of existing 2DTV compression hardware and transmission systems with minimal additional processing have been proposed. Hereafter the general term 3DTV is used to include all aspects of multichannel television and 2D will denote conventional television.

There are several methods for transmitting 3D video signals within existing compression encoding and transmission systems. For example, as shown in FIG. 1(a) one relatively simple method is to combine a left video signal and a right video signal into a single 2DTV video signal. Each picture 2 from the left hand video signal would be combined with a corresponding picture 4 from the right hand video signal to form respective first image area 6a and second image area 6b of a picture 6 of the combined video signal. The advantage of this method is that a single conventional 2DTV encoder and decoder can be used to transmit the resultant 2D video signal thus making the compression system compatible with ordinary 2D video compressors.

Another example of this method would be to combine 3DTV pictures as the top and bottom halves of a conventional picture. For example, as shown in FIG. 1(b) one relatively simple method is to combine a left video signal and a right video signal into a single 2DTV video signal. Each picture 2 from the left hand video signal would be combined with a corresponding picture 4 from the right hand video signal to form respective upper first image area 8a and lower second image area 8b of a picture 8 of the combined video signal. The advantage of this method is that a single conventional 2DTV encoder and decoder can be used to transmit the resultant 2D video signal thus making the compression system compatible with ordinary 2D video compressors.

The following descriptions are given with reference to the left/right case as illustrated by FIG. 1(a) but it is obvious to one skilled in this art that the description will also apply to the top/bottom approach as illustrated by FIG. 1(b). In each case these examples would require that the resolution of the signals be reduced by a factor of 2 in order that the bandwidth of the combined image is within the capacity of existing conventional 2DTV encoders. Whilst this may be a small disadvantage, the gain in realism of the resultant 3DTV experience could be judged as worthwhile. In principle it would easily be possible to substitute an encoder and decoder whose bandwidth is capable of maintaining full resolution using the same techniques as are described here.

In most picture material the camera movement involves translational shifts, both left/right panning as well as up/down tilting and therefore the formats shown in FIGS. 1(a) and 1(b) both have benefits. Ideally it would be useful to enable the selection of the format on a picture/picture basis or a Group of Pictures (GOP)/Group of Pictures (GOP) basis, which is appropriate depending on each individual picture sequence, rather than to impose one method. However this feature, especially the enabling of picture by picture change of format, imposes practical and performance limits which do not necessarily improve coding performance. Whilst GOP/GOP selection is possible and practical its performance improvements are not conclusive. Where field sport is being portrayed there is usually a preponderance of left/right panning movement of the camera and so, where a fixed format is to be used, this format is normally selected and so this format will be the example used in the following description.

One problem with the use of combined signals such as those shown in FIGS. 1(a) and 1(b) is that an existing conventional 2D video encoder will attempt to encode it as if it were a single conventional signal. The search area for finding motion vectors for a particular macro block may include picture information from both left and right images. In particular, near the boundary between the right and left images of a 3D pair, the motion vectors using picture information from the right hand video signal may be used to compression code the left hand video signal or vice versa, despite the picture information being taken from a very different area of the picture. This can produce unwanted artefacts near the border between the right hand signal and the left hand signal, for example at the right edge of the left hand signal or at the left edge of the right hand signal.

FIG. 2 shows a picture 10 showing an example of some artefacts which were produced as a result of using a motion vector from the right hand image area 10a to compression code part of the left hand image area 10a. FIG. 3 shows a magnified version of these artefacts. In this example the motion estimation system has chosen inappropriate vectors in the area of the grass of the football field because the grass happens to be common to both halves in different areas across the image width and will therefore be detected as viable candidate vectors.

### SUMMARY

The present invention seeks to provide a novel method of video signal coding and a novel coder for coding a video signal.

According to a first aspect of the invention, there is provided a method of coding of a video signal. The method comprises a first step of determining the presence of at least a first image area and a second image area in a picture, the images in the first image area and in the second image area being substantially identical. The method comprises a second step, in response to a positive determination, of compression coding picture information in one image area without reference to picture information in another image area.

According to a second aspect of the invention, there is provided a coder, for coding a video signal comprising an analyser for receiving picture information of a picture of the video signal, the analyser determining the presence of at least a first image area and a second image area in a picture, the images in the first image area and in the second image area being substantially identical. The coder also comprises a compression coder, coupled to the analyser to receive a positive determination therefrom, for compression coding picture information in one image area of the picture without reference to picture information in another image area in response to a positive determination.

### BRIEF DESCRIPTION OF THE DRAWINGS

The invention will now be described by way of example with reference to the accompanying drawings:

FIG. 1(a) illustrates the horizontal combination of two video signals to form a 3DTV video signal;

FIG. 1(b) illustrates the vertical combination of two video signals to form a 3DTV video signal;

FIG. 2 illustrates compression coding artefacts in a 3DTV video signal;

FIG. 3 shows the compression coding artefacts shown in FIG. 2 in more detail;

FIG. 4 is a flow chart of an exemplary method of coding of a video signal in accordance with embodiments of the invention;

FIG. 5 is a block diagram showing features of an exemplary video signal coder in accordance with an embodiment of the invention;

FIGS. 6(a)-6(f) show illustrative motion estimation search areas used in embodiments of the invention; and

FIGS. 7(a)-7(b) show illustrative motion estimation search areas used in embodiments of the invention.

### DETAILED DESCRIPTION

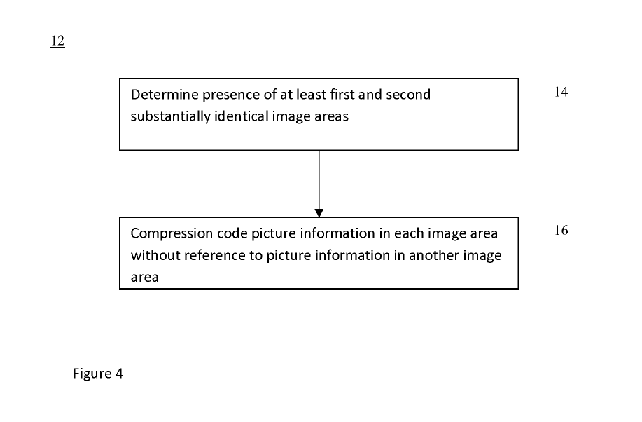

The invention will now be described with reference to FIGS. 4-7(b) of the accompanying drawings.

FIG. 4 is a flow chart of an exemplary method of coding of a video signal in accordance with embodiments of the invention.

In the exemplary method 12 shown in FIG. 4, in a first step 14, it is determined whether at least a first and a second substantially identical image area are present in a picture of the video signal.

In a second step 16, picture information in each image area is compression coded without reference to another picture area in response to a positive determination in step 14.

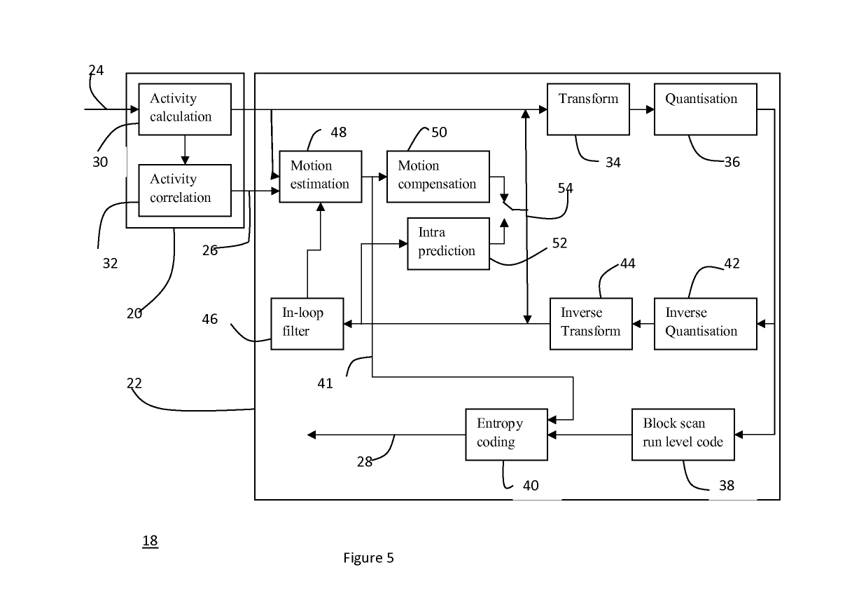

FIG. 5 is a block diagram showing features of an exemplary video signal coder 18 in accordance with an exemplary embodiment.

The exemplary video signal coder 18 comprises an analyzer 20 and a compression coder 22. The analyzer 20 is arranged to receive a video signal 24 and to analyze the video signal 24 to determine whether pictures of the video signal have at least a first and a second substantially identical image area, as set out in step 14 of the exemplary video coding method 12 shown in FIG. 4. Further details of the method of performing the analysis in the exemplary and in other embodiments of the invention, will be described in more detail hereafter.

The analyzer 20 is coupled to the compression coder 22 to supply to the compression coder 22 the video signal 24 as well as indication 26 whether pictures of the video signal 24 are determined to have at least a first and a second substantially identical image area. The compression coder 22 compression codes picture information of the video signal 24 differently depending upon whether a positive or a negative determination 26 is received, and outputs the resulting compression coded bit stream 28.

In the exemplary embodiment the compression coder 22 is a H264 compression coder. However, it will be apparent to a skilled person that the invention may be applied to other compression coders in other embodiments of the invention.

In the exemplary embodiment, the correlation between the spatial activity of different image areas is evaluated is order to determine whether at least a first and a second substantially identical image area are present within the picture, and therefore to establish the presence of a 3DTV signal. In other embodiments the determination whether at least a first and a second substantially identical image area are present within the picture may be achieved in a number of different ways.

As will be known to a skilled person, a video signal picture may be divided up into macro blocks. In the exemplary embodiment the video signal pictures are divided up into macro blocks each comprising a 16×16 array of pixels of the picture. In the exemplary embodiment, the analyser 20 determines whether pictures of the video signal 24 have at least a first and a second substantially identical image area by calculating the degree of correlation of the spatial activities of corresponding macro blocks of different image areas of video signal pictures.

Thus, in the exemplary embodiment, the analyzer 20 comprises an activity calculation element 30 and an activity correlation element 32. The activity calculation element 30 is coupled to receive the video signal 24 and is arranged to determine spatial activity of macro-blocks in a picture using the received picture information. The activity calculation element 30 is arranged to supply the macro-block activity information to the activity correlation element 32 to evaluate the degree of correlation between different image areas of a picture. The video signal 24 and the correlation indication 26 generated by the activity correlation element 32 are passed to the compression coder 22. The compression coder 22 carries out compression coding of the video signal 24.

In the exemplary embodiment, for each macro block of a picture the activity calculation element 30 calculates the spatial activity of the macro block as follows:

$$SpatialActivity = \frac{1}{128} ( {\sum }_{x = 0}^{14} {\sum }_{y = 0}^{15} \vert {Y}_{x , y} - {Y}_{x + 1 , y} \vert + {\sum }_{x = 0}^{15} {\sum }_{y = 0}^{14} \vert {Y}_{x , y} - {Y}_{x , y + 1} \vert ) \qquad ( 1 )$$

### Where:

Y_{x,y} are 8 bit luminance values for each of the 16×16 pixels forming a macro block.

The calculation of spatial activity of a macro block in equation 1 above may be implemented in any suitable manner in hardware or software, as would be known by a skilled person.

As set out above, the different image areas may be the left and right side of the screen, or the top and bottom of the picture or may be in other combinations in different embodiments. The activity correlation element 32 may thus be required to evaluate the correlation between the left and right hand areas of the picture and/or between the top and bottom areas of the picture or other picture areas in different embodiments

In the exemplary embodiment, the correlation between the macro block spatial activities in the right half of the picture and the macro block spatial activities in the left half of the picture is calculated as follows:

Firstly, the spatial activities determined by the activity calculation element 30 for macro blocks in the first image area, i.e. the left hand side of the picture in the exemplary embodiment, are combined as follows:

$$stdLeft = \sqrt{\frac{{\sum }_{N} {LeftActivity}^{2} - \frac{{\sum }_{N} LeftActivity * {\sum }_{N} LeftActivity}{N}}{N - 1}} \qquad ( 2 )$$

### Where:

N is the number of macro blocks in the left hand image area;
LeftActivity is the SpatialActivity calculated by the activity calculation element 30 using equation 1 for macro blocks in the left image area.

Similarly the spatial activities determined by the activity calculation element 30 for macro blocks in the second image area, i.e. the right hand side of the picture in the exemplary embodiment, are combined as follows:

$$stdRight = \sqrt{\frac{{\sum }_{N} {RightActivity}^{2} - \frac{{\sum }_{N} RightActivity * {\sum }_{N} RightActivity}{N}}{N - 1}} \qquad ( 3 )$$

### Where:

N is the number of macro blocks of right hand image area; and
RightActivity is the SpatialActivity calculated by the activity calculation element 30 using equation 1 for macro blocks in the right image area.

Thereafter the activity correlation element 32 can determine the correlation between the two image areas as follows:

$$\begin{matrix}Correlation = \frac{m * stdLeft}{stdRight} \\ Whereby & ( 4 ) \\ m = \frac{\begin{matrix}{\sum }_{N} ( LeftActivity * RightActivity ) - \\ \frac{{\sum }_{N} LeftActivity * {\sum }_{N} RightActivity}{N}\end{matrix}}{{\sum }_{N} {LeftActivity}^{2} - \frac{{\sum }_{N} LeftActivity * {\sum }_{N} LeftActivity}{N}} & ( 5 )\end{matrix}$$

N is the number of macro blocks in the image areas;
LeftActivity is the SpatialActivity calculated by the activity calculation element 30 using equation 1 for macro blocks in the left image area: and
RightActivity is the SpatialActivity calculated by the activity calculation element 30 using equation 1 for corresponding macro blocks in the right image area.

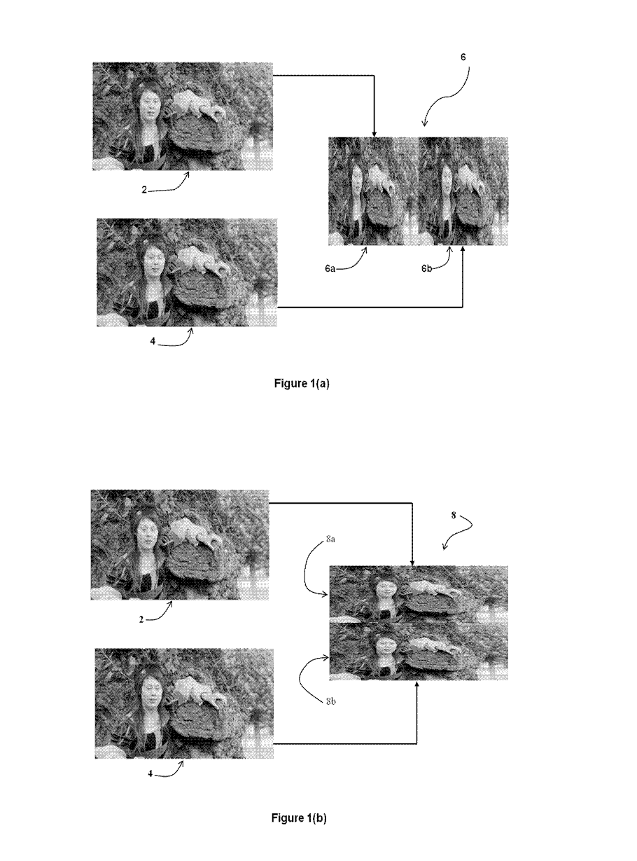

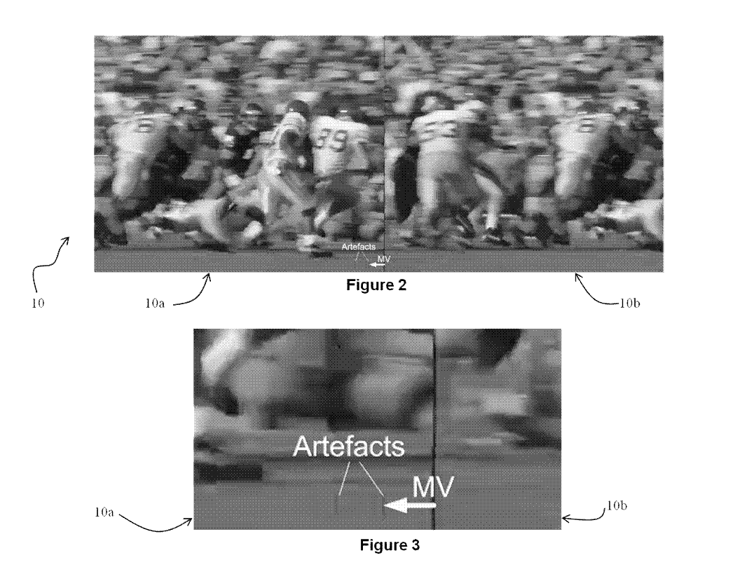

The measure correlation calculated by the activity correlation element 32 in equation 4 indicates the extent to which the different image areas, for example the right hand side of the picture and the left hand side of the picture in the exemplary embodiment, are similar to, or correlate with each other. It is to be expected that for a 3DTV image such as that shown in FIG. 1a) where the right hand side of the picture and the left hand side of the picture are almost identical, the different image areas will be found to be more highly correlated that the same areas in an average picture, and therefore the measure correlation may be used to determine whether 3DTV processing should be implemented by the compression coder 22.

In some embodiments of the invention a measure of similarity or correlation between the image areas is compared with a threshold, and a determination whether substantially similar image areas are present in the picture is made if the measure of correlation or similarity between image areas in the picture is greater than a threshold. The determination 26 is then passed from the activity correlation element 32 of the analyser 20 to the compression coder 22. The compression coder 22 compression codes the picture differently depending on whether the determination 26 is a positive determination or a negative determination.

It has been found if the correlation of the macro block spatial activities between the left and right hand portions of the signal is sufficiently high, for example when the correlation between image areas is higher than about 80%, the video signal may be detected reliably as a 3D video signal whereas the same correlation for 2D input signals is considerably less.

In the exemplary embodiment, different thresholds are used for comparison with the correlation measure, depending upon whether previous pictures of a video signal contained similar image areas. If previous picture of a video signal contained substantially similar image areas and was therefore detected as a 3DTV signal the 3DTV detection threshold is reduced since in this case, it is more likely that a new picture is part of a 3DTV video signal input. For example, the threshold may be reduced to around 70-75% correlation. A higher threshold may be used for comparison with the correlation measure if previous pictures of a video signal did not contain similar image areas, since it is less likely in this situation that the new picture is part of a 3DTV picture. A higher threshold, for example in the range 80-90% correlation may be used in this case.

It should be noted that the threshold level used to determine the presence of similar image areas in a picture may be selected by a skilled person to any level that distinguishes between 3DTV and ordinary pictures with a sufficient reliability and accuracy.

Other statistical means of calculating a reliable indicator of the presence of a 3DTV input may be used in other embodiments.

As indicated above, the determination 26 is passed from the activity correlation element 32 of the analyser 20 to the compression coder 22. The compression coder 22 compression codes the picture differently depending on whether the determination 26 is a positive determination or a negative determination.

If the determination 26 is a negative determination, the compression coder 22 compression codes the picture in accordance with standard compression coding techniques, which will be known to a skilled person.

If the determination is a positive determination, the operation of the compression coder 22 is altered in that picture information in each image area is compression coded without reference to picture information in another image area.

In the exemplary embodiment, the motion estimation process is changed by restricting the motion estimation search for a macro block in an image area to picture information in or derived from the same image area. Therefore, since picture information from a different image area is not used during compression coding, no compression coding artefacts will be generated.

The exemplary compression coder 22 will now be described in outline. As will be appreciated, the compression coder 22 of the exemplary embodiment is merely exemplary, and other embodiments may be used in other compression coders.

The exemplary compression coder 22 comprises a transform function 34, a quantisation function 36; a block scan/run level code function 38 and an entropy coding function 40, which are coupled in sequence to output a compressed bit stream 28. These blocks carry out the functions:
the transform function 34 transforms picture information for a macro block from the spatial domain into the frequency domain;
the quantisation function 36 quantises the resulting frequency domain picture information:
the block scan/run level code function 38 converts the quantised frequency information array to a stream of bits by scanning the array in a zig zag pattern and run length encoding the resulting bits using a variable length coding scheme, which uses shorter codes for commonly occurring patterns and longer codes for less commonly occurring patterns; and
an entropy coding function 40 for combining the output codes from the block scan/run level code function 38 with any corresponding motion vectors 41 (as discussed hereafter) to form a compressed bit stream 28.

Some picture information in a video signal may compressed at least in part by obtaining difference picture information, obtained by comparing the picture information to be coded with picture information elsewhere in the same picture or with picture information in one or more other pictures in the video signal, and compression coding the picture difference information using the functions set out above.

The picture information used to create the picture difference information must be picture information that is available to the decoder, and therefore the compression coder 22 also has an inverse quantiser function 42 and an inverse transform function 44 coupled between the output of the quantiser function 36 and in-loop filter 46. The in-loop filter function 46 is also coupled to an intra-prediction function 52, and the output of the intra prediction function 52 is coupled via switch 54 to the in-loop filter 46 to create decoded picture information.

The compression coder 22 is also provided with motion estimation function element 48 coupled to receive decoded picture information from the in-loop filter 46 and to receive the pictures to be coded. Typically, for each macro block to be coded the motion estimation function 48 searches within a motion estimation search area for the best match for the macro block picture information. The motion estimation function creates motion vectors 41 representing the relative position of the macro block and the picture information that was found to match with the macro block, and these motion vectors 41 are passed to the entropy coder function 40 and to the motion compensation function 50. The motion compensation function 50 uses the motion vectors 41 to create picture difference information, which is coupled via switch 54 to the transform function 34.

In the exemplary compression coder, the determination 26 is supplied to the motion estimation function element 48 of the compression coder 22. The motion estimation function element 48 limits the motion estimation search area in response to a positive determination 26 so that only picture information from the same image area is used in motion estimation search. Therefore, since picture information from a different image area is not used during compression coding no compression coding artefacts will be generated.

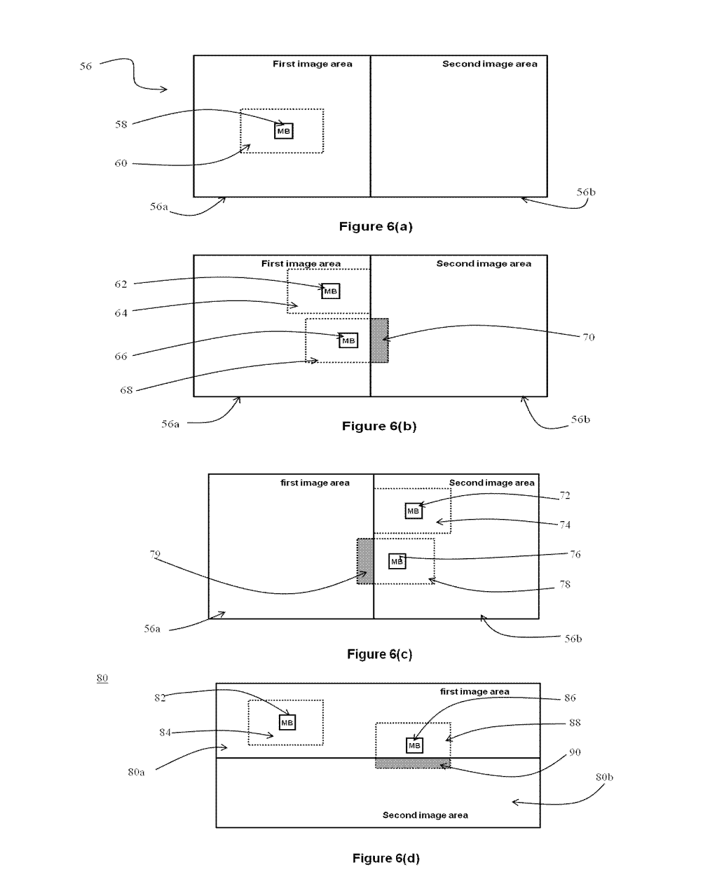

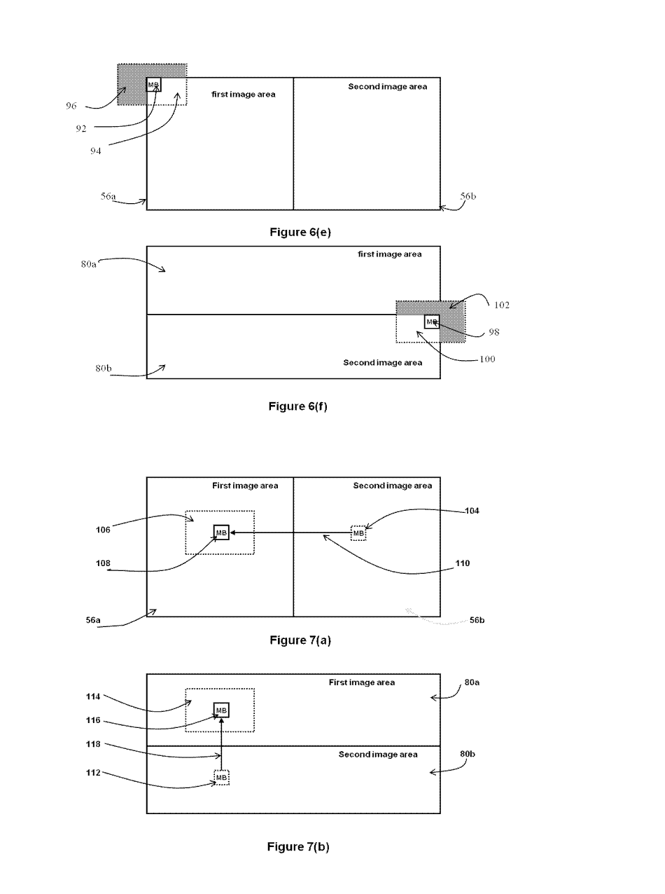

FIG. 6(a) shows a picture 56 having a first image area 56a on the left side of the picture and a second image area 56b on the right side of a picture. During compression coding of macro block 36 a motion compensation search area 60 might typically be used.

To avoid the use of inappropriate motion compensation near the boundary between the image areas 56a and 56b in the combined picture, the motion estimation search area has to be limited so as not to include picture information from the other image area.

In FIG. 6(b) macro block 62 in the first image area 56a has a motion estimation search area 64 falling within the first image area 56a and therefore the full motion estimation search area 64 may be evaluated to determine the best match.

However, macro block 66 in the first image area 56a has a motion estimation search area having a first portion 68 falling within the first image area 56a and a second portion 70 falling within the second image area 56b. The picture information from the second portion 70, falling within the second image area, is thus excluded from the allowable search area during motion estimation process.

Thus, as the encoder moves along the image horizontally and approaches the central boundary area the right hand edge of the search area is fixed so that the area of usable pixels steadily becomes smaller in the horizontal direction.

Similarly once in the right hand side the area will gradually increase horizontally until it clears the boundary. This situation is shown in FIG. 6(c) in which macro block 72 in the second image area 56b has a motion estimation search area 74 falling within the second image area 56b and therefore the full motion estimation search area 74 may be evaluated to determine the best match. In contrast, macro block 76 in the second image area 56b has a motion estimation search area having a first portion 78 falling within the first image area 56a and a second portion 79 falling within the first image area 56a. The picture information from the second portion 79, falling within the first image area 56a, is thus excluded from the allowable search area during motion estimation process.

An alternative format in which the upper and lower portions of the picture 80 form the first image area 80a and the second image area 80b is shown as FIG. 6(d). Macro block 82 in the first image area 80a has a motion estimation search area 84 falling within the first image area 80a and therefore the full motion estimation search area 84 may be evaluated to determine the best match.

However, macro block 86 in the first image area 80a has a motion estimation search area having a first portion 88 falling within the first image area 80a and a second portion 90 falling within the second image area 80b. The picture information from the second portion 90, falling within the second image area 80b, is thus excluded from the allowable search area during motion estimation process.

The exemplary method restricting the use of picture information from another image area of the picture when calculating motion vectors near the boundary between image areas may be applied to common current compression standards such as the MPEG2 and MPEG4/H264 compression standards.

In some compression standards, such as the MPEG-2 compression standard, the motion estimation search area is limited to the picture information of the video signal. However in some compression standards, such as the H264 compression standard, the permissible picture information to be included in the motion estimation search area may extend beyond the actual picture size. The picture information for the additional search area can be obtained by estimation from or extrapolating from the picture information in the actual picture. Thus it can be seen in FIG. 6(e) that the motion estimation search area for macro block 92 at the corner of the picture has a first portion 94 covering picture information from the picture, and a second portion 96 covering picture information outside the picture area, the picture information in the second portion having been extrapolated from the picture information of the picture.

In some embodiments a similar extrapolation or estimation process can be used to create picture information for use in a motion estimation search area for a macro block near the edge of an image area of a picture. In these embodiments the limitations of the motion estimation search area for a macro block within an image area of the picture can be overcome by retaining the same search area but populating the search area with picture information estimated from or extrapolated from picture information within the image area.

Thus as shown in FIG. 6(f) for the picture 80 having a first image area 80a and a second image area 80b, a macro block 98 within the second image area 80b has a motion estimation search area having a first portion 100 covering picture information from the second image area 80b of picture 80, and a second portion 102 covering picture information outside the second image area 80b, the picture information in the second portion 102 having been extrapolated from picture information in the second image area 80b. In a similar manner a motion estimation search area for any macro block around the edges of the first image area or the second image area may be extended to obtain picture information that is unavailable by extrapolating from or estimating from the picture information of the respective image area.

In the exemplary embodiment described above, the presence of the substantially identical image areas is determined by evaluating the correlation of the spatial activity in the two image areas. Additionally or alternatively, in some embodiments the presence of the substantially identical image areas may be determined based on an evaluation of motion vectors.

This method is based on the observation that the picture information in the different image areas will be very similar or substantially identical. Therefore it would be expected that a motion estimation function would find a very good match for a macro block in a corresponding position in the other image area. For example near the left edge of a combined image it is possible to get a very good match from the left side of the right image whose matching pixels are located to the right of the centre of the combined image. In this case the size of the motion vectors would be much larger than usual and equal in value to half a picture width and purely horizontal in orientation but nevertheless would be very good matches.

FIG. 7 (a) and FIG. 7 (b) illustrates the use of motion estimation in establishing the presence of the substantially identical image areas.

In FIG. 7(a) a picture has a first image area 56a and a second image area 56b. A motion estimation process is carried out for a macro block 104 using a search area 106 in the first image area 56a corresponding to the position of the macro block 104 in the second image area 56b. If the images in the first and second image areas are similar or substantially identical, as would be the case if the picture were a 3DTV picture, the motion estimation process will select a macro block 108 in first image area 56a position corresponding to the macro block 104 in the second image area 56b, and a corresponding motion vector 110 will be established. As will be apparent, the motion vector 110 has a large vector amplitude of half a picture width with no or almost no vertical component, and the presence of a number of such motion vectors would indicate the presence of an input 3DTV signal having a Left/Right format.

In FIG. 7(b) a picture has a first image area 80a and a second image area 80b. A motion estimation process is carried out for a macro block 112 using a search area 114 in the first image area 80a corresponding to the position of the macro block 112 in the second image area 80b. If the images in the first and second image areas are similar or substantially identical, as would be the case if the picture were a 3DTV picture, the motion estimation process will select a macro block 116 in first image area 80a position corresponding to the macro block 112 in the second image area 56b, and a corresponding motion vector 118 will be established. As will be apparent, the motion vector 118 has a large vector amplitude of half a picture height with no or almost no horizontal component, and the presence of a number of such motion vectors would indicate the presence of an input 3DTV signal having a top/bottom format.

Although encoding systems would not normally have search ranges extending so far away from the current macro block, in embodiments of the invention the motion estimation process can be made to make such a motion vector search as a means of detecting the presence of an input 3DTV signal. Thus if motion vectors such as motion vectors 110 and 118 described above are detected for macro blocks within a picture, the presence of the similar or substantially identical image areas can be determined.

The addition of such a stage of analysis to a compression coder would be easy to arrange since a compression coder generally carries out a motion vector grooming process in order to check for anomalous situations and to guard against false matches. This embodiment may be easily implemented by making changes to a motion estimation process, for example in some embodiments by updating software controlling the motion estimation process.

Additionally or alternatively, in some embodiments a further determination of the presence of similar or substantially identical image areas could be derived from information from a Rate Distortion Optimisation (RDO) stage of the compression coder (not shown in FIG. 5. The RDO stage of the compression coder is able to evaluate the bit cost of a first image area and the bit cost of the second image area. In a 3DTV picture, it is to be expected that the bit cost of the first image area should be generally the same as the bit cost for compression coding the second image area of the picture, since the image areas should be substantially identical. In a normal pictures, generally the bit costs of different areas will be different. Therefore the difference between the bit cost of a first image area of a picture and the bit cost of a second image area of the picture can be used to determine the presence of similar or substantially identical image areas in the picture. Again, this embodiment may be easily implemented by making changes to the RDO process, for example in some embodiments by updating software controlling the RDO stage of the compression coder.

Finally, in some embodiments it may be possible to arrange for an external indicator signal to be provided from the source of the input video signal, which would avoid the need to detect a 3DTV signal at the compression coder for a detection system. It would be possible to provide an externally generated indicator of such a presence along with the signal itself either by separate physical means or embedded in the signal. This embodiment may not be suitable for use with the hardware of conventional compression coders or of the system architectures of which they are a part.

In some embodiments one or more of the above methods are used to determine that the picture contains at least first and second substantially identical image areas.

Thus in embodiments of the invention the presence of a 3DTV input signal is detected by determining the presence of image areas. This determination is used to enable the prevention of artefacts which are produced from inappropriate choices made by the conventional encoding device.

In particular one major cause of artefacts is inappropriately motion compensated blocks of the combined 2D picture such that predictions from the left signal are used to code the right one and vice versa. In one embodiment the artefacts are removed by limiting the motion estimation search areas in both halves of the coded picture near the boundary. This avoids the unwanted use of picture information from one image area during compression coding of macro blocks from another image area.

Thus the exemplary embodiment provides a method of video coding and a video coder that can compression code conventional video signals and 3DTV video signals. This is achieved in the exemplary embodiment by modifying the compression coding depending on whether a 3DTV video signal is being compression coded. Once a 3DTV video signal is detected, the motion estimation process and its vector search area can be modified in several ways in accordance with different embodiments to take account of the changed input signal format. Motion compensated artefacts arising from the adjacent placement of the two images of the 3DTV video signal are thus reduced and general video picture quality improved.

Despite the fact that the motion estimation search area in the centre area of the combined image is restricted to each half picture, the picture quality in terms of PSNR (Peak Signal-to-Noise Ratio) is slightly improved, even in those sequences where there are no cross motion compensated artefacts. This is an unexpected but valuable result of the described method and compression coding process resulting from the allocation of bits to the various portions of the picture. At the centre of the image near the boundary where the coding may be expected to be disadvantaged by the restricted motion vector searches the additional bits required are recoverable from the rest of the image where the similarities between the two halves contribute savings to the extent that a small improvement in PSNR is noted.

In other embodiments it may be possible to combine more than two video signals and to group or interleave the pixels of the 3DTV image pair in other ways.

Embodiments may be implemented in hardware or software or in any suitable manner as will be apparent to a skilled person. In addition, although the different functions of the compression coder have been shown as separate function blocks, the different functional elements may be implemented in any combination as seems appropriate to a skilled person.

Modifications and other embodiments of the disclosed invention will come to mind to one skilled in the art having the benefit of the teachings presented in the foregoing description and the associated drawings. Therefore it is to be understood that the invention is not to be limited to specific embodiments disclosed and that modifications and other embodiments are intended to be included within the scope of this disclosure. Although specific terms may be employed herein, they are used in a generic and descriptive sense only and not for the purposes of limitation.

1. A method of coding of a video signal, the method comprising the steps of:
determining the presence of at least a first image area and a second image area in a picture, the images in the first image area and in the second image area being substantially identical; and
in response to a positive determination, compression coding picture information in one image area without reference to picture information in another image area.

2. The method of coding as claimed as claim 1 wherein the step of determining comprises the step of determining the presence of at least a first image area and a second image area from picture information of the picture.

3. The method of coding as claimed in claim 1 wherein the step of determining comprises the step of comparing the degree of correlation between macro-blocks within the first image area and the second image area.

4. The step of coding as claimed in claim 3 wherein the step of determining the presence of at least a first image area and a second image area results in a positive determination if the degree of correlation between macro-blocks in a first image area and a second image area is greater than a correlation threshold.

5. The step of coding as claimed in claim 4 wherein the step of determining the presence of at least a first image area and a second image area in a picture results in a negative determination if the degree of correlation between macro-blocks in a first image area and a second image area is less than a lower correlation threshold.

6. The method of coding as claimed in claim 1 wherein the step of determining comprises the step of determining the spatial activity of the first image area and the second image area.

7. The method of coding as claimed in claim 1 wherein the step of determining comprises the step of detecting high amplitude substantially horizontal or substantially vertical motion vectors for a plurality of macro blocks of a picture.

8. The method of coding as claimed in claim 1 wherein the step of determining comprises the step of comparing the compression coded bit rate for a first image area and the compression coded bit rate of a second image area, and determining the presence of first and second image areas if the compression coded bit rates for the first image area and for the second image area are similar or substantially identical.

9. The method of coding as claimed in claim 1 wherein in the step of compression coding, motion estimation search areas are confined to picture information in the same image area.

10. The method of coding as claimed in claim 9, also comprising the steps of creating picture information outside an image area from picture information within the image area and performing a motion estimation process using the created picture information.

11. A coder, for coding a video signal comprising
an analyser for receiving picture information of a picture of the video signal, the analyser determining the presence of at least a first image area and a second image area in a picture, the images in the first image area and in the second image area being substantially identical; and
a compression coder, coupled to the analyser to receive a positive determination therefrom, for compression coding picture information in one image area of the picture without reference to picture information in another image area in response to a positive determination.

12. The coder as claimed in claim 11, wherein the analyser compares the degree of correlation between macro-blocks within the first image area and the second image area.

13. The compression coder as claimed in claim 12 wherein the analyser determines the presence of at least a first image area and a second image area if the degree of correlation between macro-blocks in a first image area and a second image area is greater than a correlation threshold.

14. The compression coder as claimed in claim 13 wherein the analyser determines that a first image area and a second image area are not present if the degree of correlation between macro-blocks in a first image area and a second image area is less than a lower correlation threshold.

15. The method of coding as claimed in claim 1 wherein the analyser comprises an activity calculation element for determining the spatial activity of the first image area and the second image area.

16. The compression coder as claimed in claim 11 wherein the motion estimator detects high amplitude substantially horizontal or substantially vertical motion vectors for a plurality of macro blocks of a picture.

17. The compression coder as claimed in claim 11 wherein the analyser is a rate distortion optimizer (RDO) arranged to compare the compression coded bit rate for a first image area and the compression coded bit rate of second image area, and determining the presence of first and second image area if the compression coded bit rates for the first image area and for the second image area are similar or substantially identical.

18. The compression coder as claimed in claim 11 wherein during compression coding of picture information from an image area, the motion estimator of the compression coder uses a motion estimation search area confined to picture information in the same image area.

19. The compression coder as claimed in claim 18 wherein the motion estimator creates picture information outside an image area from picture information within the image area prior to performing a motion estimation process using the created picture information.
